(19) United States
(12) Patent Application Publication
(10) Pub. No.: US 2026/0100900 A1
(43) Pub. Date: Apr. 9, 2026

(54) SERVICE OUTAGE DETECTION AND CUSTOMER SUPPORT TICKET MANAGEMENT SYSTEM AND METHOD USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE)

(73) Assignee: Trilogy Enterprises, Inc., Austin, TX (US)

(21) Appl. No.: 19/352,442

(22) Filed: Oct. 7, 2025

Related U.S. Application Data
(60) Provisional application No. 63/704,544, filed on Oct. 7, 2024.
(60) Provisional application No. 63/711,692, filed on Oct. 24, 2024.

(51) Int. Cl. H04L 43/0817; G06Q 30/016; H04L 41/0631

(52) U.S. Cl. CPC H04L 43/0817; G06Q 30/016; H04L 41/0631

(57) ABSTRACT

The Artificial Intelligence driven service outage detection and customer support ticket management system in customer support platforms includes a customer support platform that is operatively coupled to the service outage detection system. A data collector gathers input data from a product status page and a service request tracker document. A service outage detector (SRT) detects the service outage by monitoring the product status page and incoming customer support tickets raised against the products by the users. A comparator compares the details of the product status page and the SRT document to confirm the occurrence of the service outage. A customer support ticket router updates the customer support ticket routing process based on the confirmed service outage status. A response generator generates an automated, predefined response including service outage information and any expected resolution or alternative support options and notifies the user utilizing a notification module.

### CROSS-REFERENCE TO RELATED APPLICATION(S)

This application claims the benefit under 35 U.S.C. § 119(e) and 37 C.F.R. § 1.78 of U.S. Provisional Application Nos. 63/704,544 and 63/711,692, which is incorporated by reference in its entirety.

This application incorporates by reference the following U.S. patent application Ser. Nos. 19/352,268, 19/352,290, 19/352,299, 19/352,309, 19/352,318, 19/352,327, 19/352,333, 19/352,347, 19/352,353, 19/352,361, 19/352,365, 19/352,376, 19/352,384, and 19/352,436.

### FIELD OF THE INVENTION

The present invention relates in general to the field of electronics, and more specifically a system that utilizes Artificial Intelligence (AI) for service outage detection by deflecting and routing the tickets and informing the user about the disruption in the service. The data from a product status page is analyzed on a real-time basis to determine the current operational status of the service outage.

### BACKGROUND OF THE INVENTION

In the current landscape, the efficient management of customer support systems is crucial for all online platforms. Prompt responses to customer care inquiries are essential for improving the customer experience and maintaining higher retention rates. Conventional customer support ticket management systems usually require multiple manual stages, which can impede communication and resolution, particularly during service outages. Customer support staff have traditionally relied on manual procedures to update ticketing systems and notify consumers about service outages. This is a time-consuming process and may lead to error generation.

Traditional methods include processes like manual monitoring and detection, updating ticket responses, and communicating with customers. For manual monitoring and detection, the support teams or IT staff must be aware of the service outage, either through internal monitoring systems or customer reports. Once they are aware of the service outage, the support staff manually update the ticketing system to reflect the outage, which can be time-consuming and prone to human error. The process of communicating with customers about the outage usually entails manually crafting and sending bulk notifications, which may not be timely or specific to the customer's inquiry. These procedures are not only resource-intensive but also sluggish, which can exacerbate customer frustration during the duration of outages. Furthermore, the absence of automation in the detection and communication of disruptions results in customers waiting for responses for an extended time and the potential for a flood of tickets into the support system, which could overwhelm the support staff.

Conventional automated response systems also include static automated response systems and basic ticket routing systems. The static automated response systems can automatically send predefined responses to tickets based on keywords or categories. However, they are incapable of dynamically updating or adapting according to real-time outage data, thereby leading to inaccurate or irrelevant responses during actual outages. The basic ticket routing systems route tickets to appropriate teams or departments based on predefined rules or categories. These systems cannot automatically adjust routing based on current outage status without integrating real-time data, which could potentially overwhelm certain teams with tickets they could have deflected.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary Artificial Intelligence (AI) driven service outage detection system by managing customer support tickets raised by a user using a customer support platform.

FIG. 2 depicts an exemplary Artificial Intelligence (AI) driven service outage detection process by managing customer support tickets raised by a user using a customer support platform.

FIG. 3 depicts an exemplary customer ticket management process, which is an embodiment of the Artificial Intelligence (AI) driven service outage detection process by managing customer support tickets raised by a user using a customer support platform of FIG. 2.

FIG. 4 depicts an exemplary database for storing the unique structured routing document (SRT) tailored for machine learning models.

FIG. 5 depicts an exemplary ticket handling process for managing and resolving customer tickets, which is an embodiment of the Artificial Intelligence (AI) driven service outage detection process by managing customer support tickets raised by a user using a customer support platform of FIG. 2.

FIG. 6 depicts an exemplary spreadsheet disclosing the details of the SRT document available on the product status page.

FIGS. 7 and 8 depict exemplary user interfaces disclosing a product status page showing a list of queries 706 raised by the user and the status of the queries raised, respectively.

FIG. 9 depicts an exemplary network environment in which the Artificial Intelligence (AI) driven service outage detection system by managing customer support tickets raised by a user using a customer support platform of FIG. 1 and the Artificial Intelligence (AI) driven service outage detection system by managing customer support tickets raised by a user using a customer support platform of FIG. 2 may be practiced.

FIG. 10 depicts an exemplary computer system.

### DETAILED DESCRIPTION

An Artificial Intelligence (AI) driven service outage detection system by managing customer support tickets raised by a user using a customer support platform is disclosed. The AI-driven service outage detection system includes a customer support platform that is operatively coupled to a ticket management module. A data collector is integrated into the ticket management module and is configured to collect input data from a product status page and a service request tracker (SRT) document. The collected input data is then provided to a service outage detector, which is configured to detect the service outage by monitoring the product status page and incoming customer support tickets raised against one or more products by one or more users. A comparator is integrated into the ticket management module and is configured to compare details of the product status page and the SRT document to confirm the occurrence of the service outage. A customer support ticket router is integrated into the ticket management module and is configured to update the customer support ticket routing process based on the confirmed service outage status. A response generator generates an automated, predefined response for the user, informing them of the service outage and providing relevant information or instructions. A notification module is operatively coupled to the ticket management module and notifies the user about the service outage with a predefined response, including service outage information and any expected resolution or alternative support options.

The AI-driven service outage detection system uses real-time data from the product status page and specific text fields in the SRT document to deflect tickets and inform users about the service disruption. By automating the detection and communication process, the AI-driven service outage detection system reduces the workload on customer support teams and decreases the response time to customer inquiries during outages. This leads to improved customer experience and potentially higher retention rates. The AI-driven service outage detection system is specifically designed for use within customer support platforms that handle a high volume of service requests or tickets. This integration allows the AI-driven service outage detection system to automatically detect service outages and manage customer tickets accordingly without human intervention.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.

3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

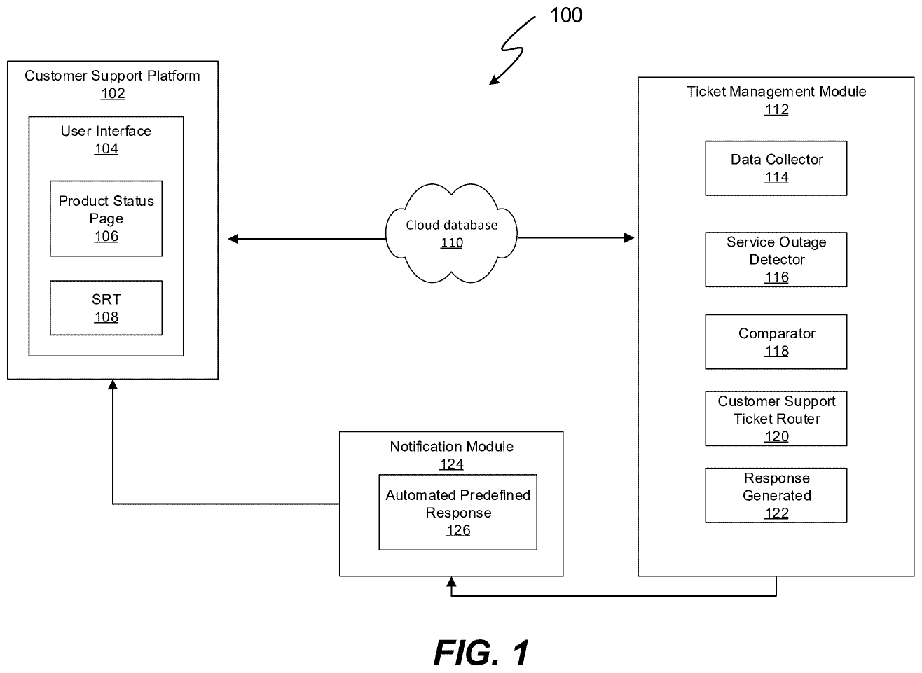

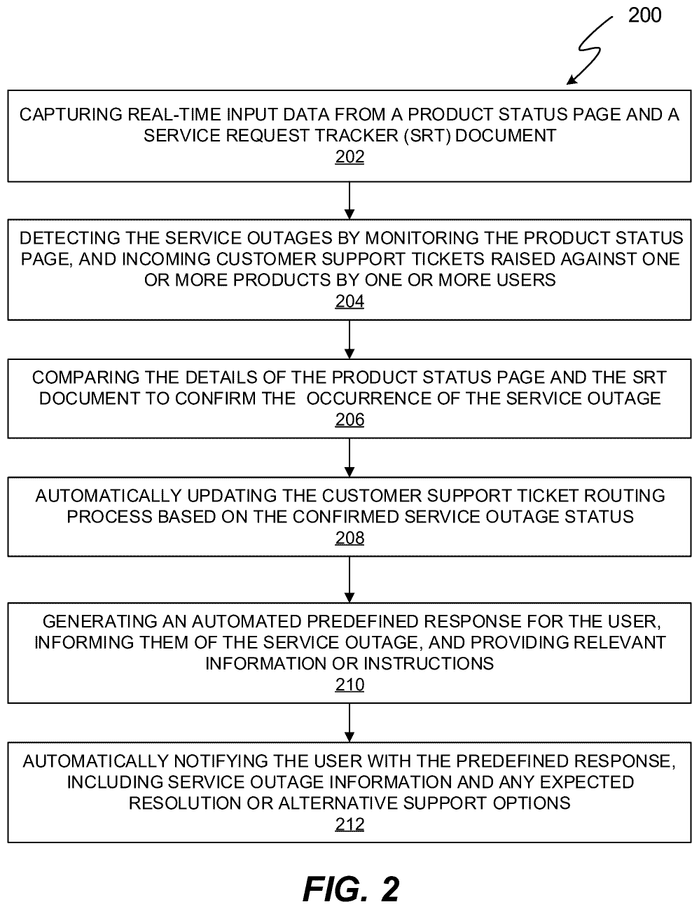

FIG. 1 depicts an exemplary Artificial Intelligence (AI) driven service outage detection system 100 by managing customer support tickets raised by a user using a customer support platform 102. FIG. 2 depicts an exemplary Artificial Intelligence (AI) driven service outage detection process 200 for managing customer support tickets raised by the user using the customer support platform 102.

Referring to FIGS. 1 and 2, in operation 202, a data collector 114 collects the input data from a product status page 106 and a service request tracker (SRT) document 108.

The data collector 114 is integrated within a ticket management module 112, which is operatively coupled to the customer support platform 102. The data collector 114 captures input data from multiple sources, including the product status page 106 and the service request tracker (SRT) 108 in real-time. This means that after each pre-defined interval, the data collector 114 gathers new input data ensuring up-to-date information capture related to service outages and customer tickets.

The input data gathered from these sources serve multiple purposes. For instance, the product status page 106 data provides functional status related to a service, which is used to determine whether the page is functional or experiencing any service outages. The service performance, service outage notifications, or scheduled maintenance alerts are continuously monitored at predefined intervals for real-time updates on the product status page 106. This is crucial for determining whether the user is raising the support ticket because of the non-functioning of the page.

Further, the service request tracker (SRT) 108 is used for receiving and managing key inquiries. For example, the SRT 108 document manages and monitors service requests raised by users, such as customers. These requests typically involve issues like software installations, access requests, equipment maintenance, general inquiries, or product-related issues. When a service request is made, it is logged into the customer support platform 102 as a ticket, which includes essential details such as nature of the request, user information, priority level, and any relevant documentation.

The SRT 108 assigns each request a unique ticket number, allowing for easy tracking and monitoring. Real-time status updates are provided to both the user and the support team, ensuring transparency in the progress. The SRT 108 ensures that requests are assigned to the appropriate teams, managed efficiently, and resolved within agreed timelines, improving overall user satisfaction.

The service request tracker 108 tracks the different service tickets raised by the customer and provides information related to the present service outages and the tickets raised by the customers to the data collector 114. The SRT document 108 includes a status page ID accompanied by an alphanumeric code. The alpha-numeric code contains an instruction that enables detection of the service outage issue. The SRT document 108 contains fields for Category, Description, Team, and Required Information. The ‘Category’ field is used to classify the request based on the type of service or issue, helping to route it to the appropriate team. The ‘Description’ field provides a detailed explanation of the request or issue, ensuring that the handling team has enough context to address the problem effectively. The ‘Team’ field specifies which team or department manages and resolves the request. Finally, the ‘Required Information’ field lists any additional details or documentation needed to initiate the request, ensuring that all necessary information is provided for a smooth resolution. These fields collectively handle the service requests within the customer support platform 102. The design of each field enhances the accuracy and efficiency of ticket routing by facilitating machine learning processing.

Each customer ticket type is categorized with a short heading and accompanied by a description that is friendly to large language models (LLMs). The details provided to machine learning models help in training the machine learning models thereby increasing the efficacy of the machine learning models. The SRT 108 document specifies which team (e.g., automation, Level 1 support, Level 2 support, business unit, etc.) should receive the ticket. This targeted routing is crucial for ensuring that tickets are handled by the most appropriate and capable team, reducing response times, thereby improving resolution efficiency.

The SRT document 108 specifies information that must be included in the ticket to ensure that it is processed efficiently. The SRT 108 is equipped with mechanisms that detect outages and automate the deflection of related tickets, informing customers about the outage through predefined responses. This feature not only improves customer service but also alleviates the burden on support teams during periods of high volume.

In operation 204, a service outage detector 116 detects the service outages by monitoring the product status page 106 and incoming customer support tickets raised against one or more products or services by one or more users.

The service outage detector 116 is integrated within the ticket management module 112 and receives the input data from the data collector 114. The service outage detector 116 uses machine learning algorithms to detect service outages by identifying patterns in the customer support tickets received from the data collector 114. The service outage detector 116 detects the service outage and the incoming customer support tickets from the input data provided by the data collector 114 with the help of NLP (Natural Language Processing) techniques.

This service outage detector begins the service outage detection by capturing input data from the product status page 106 at regular predefined time intervals. The data from the product status page 106 is taken periodically to understand the functioning of the page at each time interval. This ensures that the data collector 114 collects a continuous series of data that represents the functional or nonfunctional status of the page.

The service outage detector 116, upon receiving the product status page data utilizes NLP (Natural Language Processing) techniques and confirms the outage of the service page. The Natural Language Processing technique monitors the status page for outage indicators. The SRT document 108 includes a status page ID accompanied by an alphanumeric code. This alphanumeric code contains an instruction that enables detection of the service outage issue. The SRT document 108 may also include a status page component along with the status page ID. For instance, the status page ID includes ‘sdy2gzppwxh8’ and the status page component includes ‘hp29vjvclbxk’. The user can access the product status page 106 which displays various status page ID and status page components. The Status Page ID refers to a unique identifier that connects the service request to the product status page 106, where users can view real-time updates on the current state of various services. The Status Page Component pinpoints which section or component of the broader service is impacted or being worked on.

The Natural Language Processing technique checks the incoming tickets for keywords or phrases that depict service outages listed in the service request tracker (SRT) 108. The service outage detector 116 utilizes NLP (Natural Language Processing) techniques to analyze the incoming customer support tickets and identify potential service outages based on user-submitted keywords or patterns.

The text is extracted from the SRT document 108 by identifying and retrieving key information related to current service outages and ticket routing. This extraction focuses on fetching critical details that highlight ongoing service disruptions, which are essential for both users and support teams to understand the scope and impact of the issue. Information about current service outages typically includes the affected services, the nature of the disruption, expected downtime, and any updates on resolution progress.

In addition to outage information, the extracted text also includes data relevant to ticket routing, which ensures that service requests are directed to the appropriate teams or departments for resolution. This might involve identifying the category of the issue, determining the affected component, and matching it with the correct team based on predefined workflows. Accurate extraction of this routing information is critical for ensuring that tickets are processed efficiently, minimizing delays in response and resolution.

In operation 206, a comparator 118 compares the product status page 106 and the SRT document 108 to confirm the occurrence of the service outage.

The comparator 118 is integrated within the ticket management module 112. The service outage detector 116 identifies patterns in the incoming customer support tickets to detect service outages using machine learning algorithms. The service outage detector 116 utilizes NLP (Natural Language Processing) techniques to analyze incoming customer support tickets and identify potential service outages based on user-submitted keywords or patterns.

Once the service outage detector 116 detects the service outage, the comparator 118 confirms the outage by comparing the identified keywords, or phrases with the predefined service outage-related terms in the SRT 108 document. The comparator 118 compares the information on the product status page 106 and the SRT document 108 to make sure that the service outage that was found by the service outage detector 116 happened.

The service outage detector 116 involves a multi-step approach that helps identify disruptions by analyzing customer support tickets. The first way to detect service outages includes three key steps, namely, monitoring individual customer support tickets, analyzing similarities across tickets, and scanning for common keywords. By monitoring the details of each ticket, the service outage detector 116 examines the nature of the issue described by the customer to spot potential service-related problems. When multiple customers raise support tickets for the same product or service, the comparator 118 monitors similarities between these tickets to detect recurring issues that may signal an outage. Additionally, the comparator 118 scans incoming tickets for shared keywords or phrases that frequently appear in outage-related reports. This helps in identifying trends that indicate an ongoing service disruption.

The second way to detect service outages utilizes more advanced techniques such as Natural Language Processing (NLP) and machine learning algorithms to enhance the detection process. NLP is used to scan incoming tickets for specific keywords or phrases that describe service issues. The comparator 118 then compares the keywords with predefined terms stored in the SRT document 108, which are associated with known service outages. The comparator 118 ensures that the comparison made accurately matches the language used by the users with common outage descriptors. Furthermore, comparator 118 uses machine learning algorithms to detect patterns in the ticket data. By identifying recurring patterns in how users report issues, machine learning algorithms can predict or confirm a service outage.

In operation 208, a customer support ticket router 120 performs the routing of the customer support ticket and thereby deflects the customer support ticket from the direct intervention of supporting staff.

Customer tickets raised outside of the service outage only are supposed to be handled by support professionals. The intervention of support staff in customer tickets regarding service outages results in ticket flooding and, as a result, time delays. The service outage detector 116 detects and confirms the service outage. The customer support ticket router 120 automatically updates the customer support ticket routing. The automatic updating of the customer support ticket routing causes the deflection of customer service tickets from the direct intervention of supporting staff. As a result, the customer support ticket router 120 ensures that only the customer tickets raised, not because of service outages, will reach the hands of the supporting staff for resolutions.

In operation 210, a response generator 122 generates an automated predefined response 126 for the user, informing them of the service outage and providing relevant information or instructions.

The response generator 122 is integrated with the ticket management module 112. The comparator 116 confirms the outage detected by the service outage detector 116 by comparing the details of the product status page 106 and the SRT document 106. The comparator 116 compares the identified keywords, or phrases with the predefined service outage-related terms in the SRT document 108.

Once the outage is detected, the customer support ticket router 120 deflects the customer service tickets raised out of service outages from the direct intervention of the supporting staff and sends the same to the response generator 122. The response generator 122 generates the automated predefined response 126 for the user, informing them of the service outage, and providing relevant information or instructions.

The code used in the Artificial Intelligence (AI) driven service outage detection system 100 to generate a response for the user when a ticket is raised by the user is given below:

A cloud database 110 is functionally coupled to the customer support platform 102 and the ticket management module 112 to store historical service outage data, customer interactions, and predefined response templates for future reference and continuous improvement of the service outage detection.

In operation 212, a notification module 124 automatically notifies the user with the automated predefined response 126, including service outage information, any expected resolution, or alternative support options.

The notification module 124 receives the automated predefined response 126 from the response generator 122. The notification module 124 then notifies the user by displaying the automated predefined response 126, which includes service outage information, any expected resolution, and alternative support options, on the user interface 104. The user is presented with alternative support options, such as FAQs, assistance articles, or status updates, which can resolve user issues.

For instance, when the user raises a service ticket because of an issue like a defect in the product, and so on, the user will get an automated predefined response 126 along with the information and alternative support options like FAQs and help articles. The FAQs include predefined questions and corresponding answers related to the service outage, like the average time to clear the outage or when the service will be available again. The customer can check the FAQs to clarify his queries related to the service outage.

The user interface 104 is integrated into the customer support platform 102 and is configured to present the final result to the user. The final result includes the automated predefined response 126, the service outage information, any expected resolution, or alternative support options for the service outage. This user interface 104 provides immediate response to the customer on the service outage and customer tickets in the customer support platform 102. The notifications generated by the notification module 124 are displayed to the user on the user interface 104 of the customer support platform 102.

The pseudocode used in the Artificial Intelligence (AI) driven service outage detection system 100 by managing customer support tickets raised by a user using a customer support platform 102 is given below:

function handleTicket(ticket):
status = checkStatusPage( )
if status indicates outage:
if ticket.description contains keywords from SRT:
sendOutageNotification(ticket.customer)
deflectTicket(ticket)
else:
routeTicket(ticket)
else:
routeTicket(ticket)

The pseudo-code used in the AI-driven service outage detection system 100 for ticket handling uses the function ‘handleTicket (ticket)’ function to process the customer support ticket based on the current product status page 106 and the ticket's description. First, the checkStatusPage( ) function is called to determine if there is an ongoing service outage. If the status indicates an outage, the function then checks if the ticket's description contains specific keywords from the SRT 108 that are related to known issues. If these keywords are found, the function sends an outage notification to the affected customer to inform them of the situation. As a next step, the AI-driven service outage detection system 100 deflects the ticket, i.e., it prevents further processing, as the issue is already acknowledged as part of the outage. If no relevant keywords are found in the ticket description, or if no outage is detected in the product status page 106, the ticket is routed for regular handling and further action. This ensures that the customer tickets related to ongoing outages are automatically managed, while other issues are handled by separate support procedure.

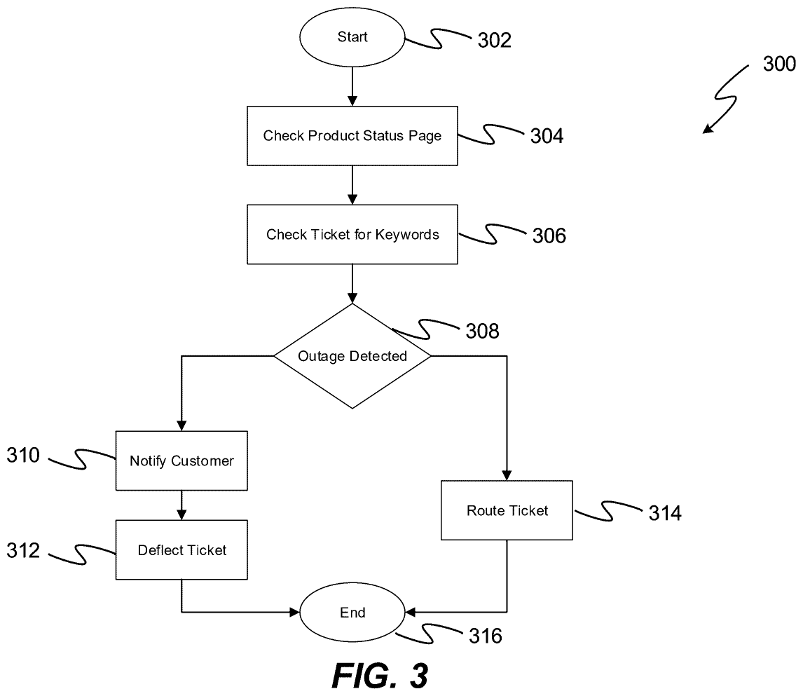

FIG. 3 depicts an exemplary customer ticket management process 300, which is an embodiment of the Artificial Intelligence (AI) driven service outage detection process 200 for managing customer support tickets raised by customers via the customer support platform 102.

The customer ticket management process 300 illustrates the detection of a service outage and the corresponding management of customer tickets in customer support platforms 102. The customer ticket management process 300 starts when the customer submits a ticket 302 reporting an issue with a service in the customer support platform 102. When the customer raises a service ticket, the ticket management module 112 evaluates 304 the functionality of the product status page 106 by analyzing the data from the product status page 106, which is received through the data collector 114.

The ticket management module 112 also checks tickets for keywords 306 that match the description in the SRT 108 related to the outage. The service outage detection system 112 does the outage detection 306 with the help of a service outage detector 116 and confirms 308 the outage by utilizing the comparator 118. The service outage detector 116 integrated within the ticket management module 112 monitors the product status page 106 and incoming customer support tickets raised against one or more products by one or more users. The service outage detector 116 utilizes machine learning methods to discern patterns in customer support tickets received from the data collector 114 to detect service outages. Comparator 118 compares the details of the product status page 106 and the SRT document 108 to confirm the occurrence of the service outage.

The notification module 124 upon detection of the service outage notifies the customer 310 by utilizing with the automated predefined response 126, which is generated by the response generator 122 integrated with the ticket management module 112. The automated predefined response 126 also includes information about the outage status, any expected resolution, and alternative support options. The resolution, or alternative support options presented to the user include FAQs, help articles, or status updates that can resolve user issues. The user interface 104 displays the automated predefined response 126, along with details about the outage status, any expected resolution, or alternative support options for the customer.

Upon confirmation of the service outage, the customer support ticket router 120, located in the ticket management module 112, automatically routes the customer support ticket 314 according to the confirmed service outage status. The customer support ticket router 120 deflects ticket 312 from the direct intervention of the supporting staff. In such a scenario, the response generator 122 generates an automated predefined response 126, which is notified 310 to the customer with the help of a notification module 124. By doing this, the customer support ticket router 120 guarantees that only raised customer support tickets, not those resulting from service outages, reach the supporting staff for resolution. This will help to reduce human intervention and time consumption in the customer support ticket management process 300.

The customer support ticket router 120 routes ticket 314 to the hands of the proper supporting staff to provide solutions in the instance that the outage is not detected. Once the supporting staff receives the issue, the customer gets notified at end 316.

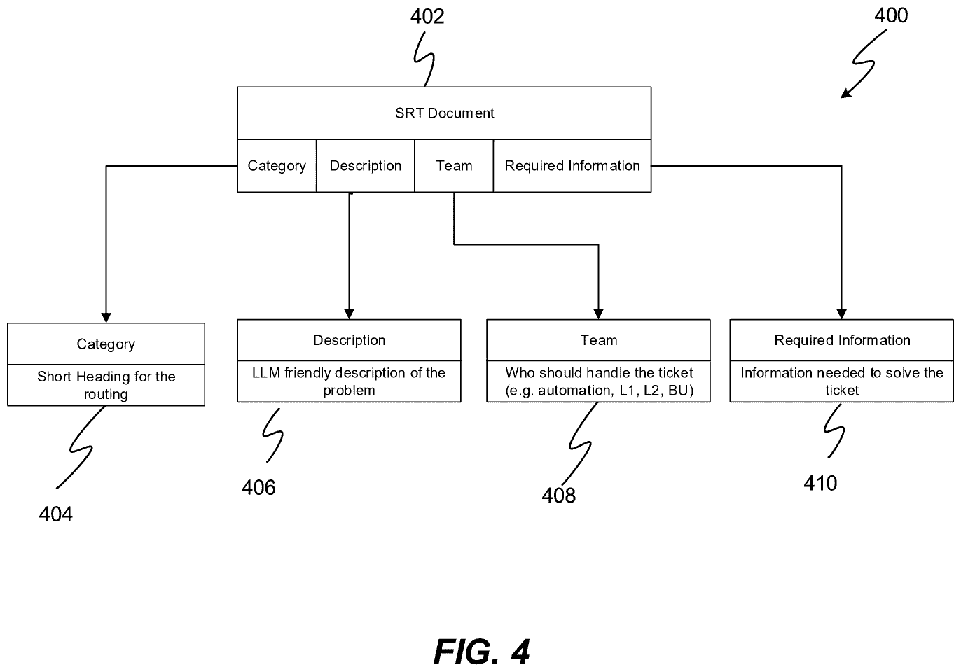

FIG. 4 depicts an exemplary data structure for storing the unique structured routing document (SRT) 400 tailored for machine learning models.

The structure of SRT 402 is one of a kind and has been developed with Artificial Intelligence processing in mind. Especially in the context of ticket routing, this architecture makes it easier for artificial intelligence to absorb new information and react to changing circumstances. The SRT document 402 contains fields for Category 404, Description 406, Team 408, and Required Information 410. To improve the precision and effectiveness of ticket routing, each field has been designed to be receptive to the processing of machine learning.

The customer ticket types are divided into different categories. Each customer ticket type is includes a short heading and a description 406, which makes it friendly to the large language models (LLMs). The SRT document 402 specifies each customer ticket's category 404. The short heading provides information about the type of customer ticket, resulting in efficient ticket routing. The description 406 of the problem is LLM-friendly, which facilitates more effective learning and adaptation by AI. This organized approach enhances the effectiveness of machine learning model training by providing clear, concise, and relevant data sources for Artificial Intelligence to absorb and learn from.

Category 404 provides a short heading to each ticket type, providing a concise overview of the issue, and Description 406 provides a detailed description that is specifically designed to be interpreted by large language models (LLMs). This structured, clear, and relevant data is beneficial for training machine learning models, enabling them to process and learn from the data more effectively.

The Team Routing Information 408 defines which team is responsible for addressing the ticket. Whether it's automation, Level 1 (L1) or Level 2 (L2) support or a specific business unit, the document ensures that the ticket is routed to the most appropriate and capable team. This targeted approach not only reduces response times but also improves the efficiency of ticket resolution by assigning the task to the team best suited to handle it.

The Required Information 410 specifies what data must be included in the ticket for it to be processed correctly. This ensures that when the ticket is reviewed, it can quickly determine whether all necessary information is present. If complete, the ticket can be processed efficiently; if not, the model can flag it, prompting for the missing details. This leads to faster routing decisions and more accurate handling of issues.

Different types of customer tickets are handled by different customer support teams, including automation, Level 1 support, Level 2 support, and business units. The SRT document 402 indicates which team should receive the ticket 408. This tailored routing plays a crucial role in assigning tickets to the most relevant and capable team, thereby reducing response times and enhancing resolution efficiency. For instance, when the SRT document 402 indicates the team as ‘automation’, then the customer ticket gets deflected by the router from the direct intervention of the supporting staff, and the customer is provided with an automated predefined response. When the SRT document 402 designates the team as ‘Level 1 support’, it directs the customer ticket to the Level 1 supporting staff for assistance.

In addition, the SRT document 402 details the required information 410 that must be included in the ticket to guarantee that it is processed and handled effectively. Consequently, this guarantees that the Artificial Intelligence model can rapidly analyze the presence of all relevant data, which in turn makes it possible to make routing decisions that are both rapid and accurate.

The SRT 402 is outfitted with systems that can identify outages and automatically redirect tickets that are associated with them. Additionally, it alerts customers about the outage by providing them with predetermined responses. This functionality not only enhances the quality of service provided to customers but also reduces the workload expected of support teams during times of high volume. The specific architecture of the SRT 402 is designed to be amenable to machine learning, which directly tackles the inefficiencies and restrictions that were discovered in the alternatives.

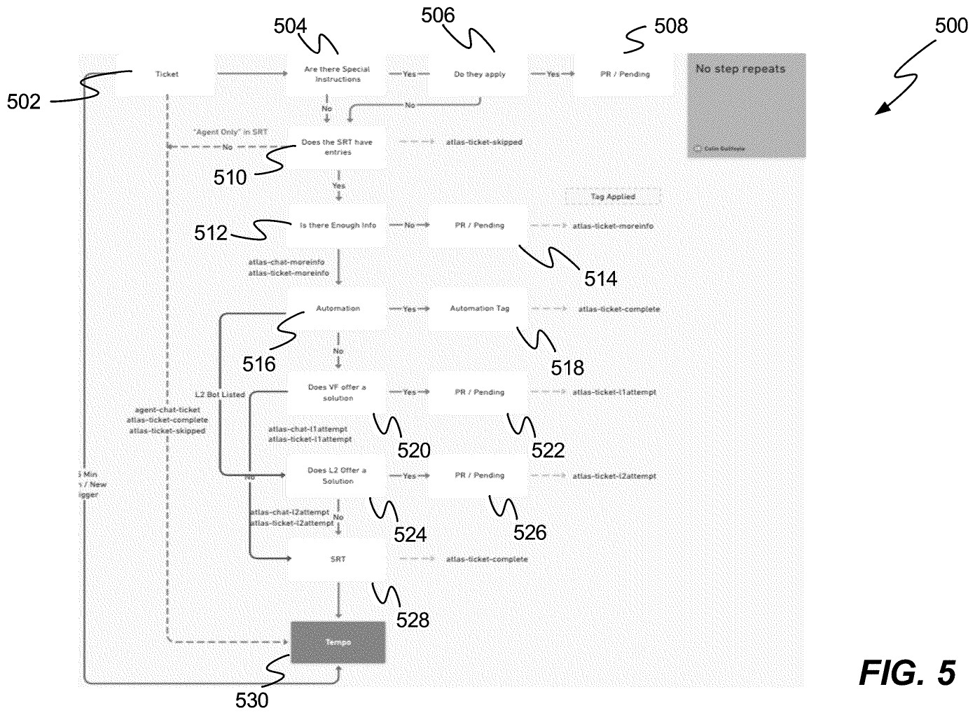

FIG. 5 depicts an exemplary ticket handling process 500 for managing and resolving customer tickets, which is an embodiment of the AI-driven service outage detection process 200 of FIG. 2.

The ticket handling process 500 for managing and resolving customer tickets involves multiple decision points to ensure efficient handling. The ticket handling process 500 for managing and resolving customer tickets starts when a ticket is raised by user 502, which initiates evaluating and resolving the issue. The first decision point is to check whether there are specific instructions related to ticket 504.

If specific instructions are available, the next step is to determine if they apply to the current issue 506. If they do, the ticket is marked as PR/pending 508, i.e., it's put into a queue for further action or resolution. PR stands for Problem Record. A Problem Record is typically used in service management to track and manage problems or issues that require further investigation, resolution, or follow-up. When a ticket is marked as PR/pending, it means that the issue is recorded as a problem that is awaiting further action or resolution. However, if no specific instructions apply, the ticket handling process 500 moves to check whether the Service Request Tracker SRT 108 has any existing entries for ticket 510.

If the SRT 108 contains entries, the next decision point is to check whether there is enough information available 512 to resolve the ticket. If the information is incomplete, the ticket is again marked as PR/pending 514. However, if there is sufficient information, the ticket handling process 500 proceeds to Automation 516. If the issue can be handled by automation, an Automation tag 518 is applied to the ticket, i.e., the problem will be resolved automatically without further human intervention. However, if automation does not start or cannot fully resolve the issue, the next step is to determine whether VF (Virtual Functionality) offers a solution 520. VF stands for Virtual Functionality and refers to automated systems or virtual agents that attempt to solve issues without human intervention. Virtual Functionality often includes AI-powered systems, chatbots, or automated workflows that handle routine tasks or provide solutions based on predefined rules or algorithms.

If VF offers a solution, the ticket is moved to PR/pending 522, awaiting resolution. If VF cannot resolve the issue, the next step is to check if L2 (Level 2) support provides a solution 524. If L2 can resolve it, the ticket is also put into the PR/pending queue 526. If neither VF nor L2 offers a solution, the ticket handling process 500 provides the SRT 108 to agent 528, where the agent manually reviews and resolves the issue. Finally, the SRT 108 is handed to the agent for resolution 530.

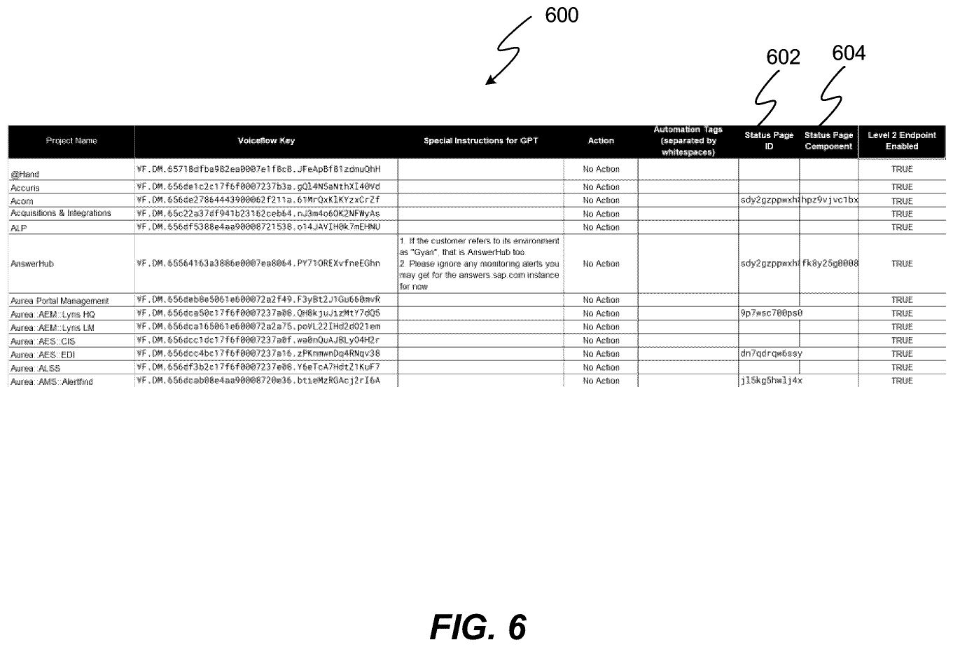

FIG. 6 depicts an exemplary spreadsheet 600 disclosing the details of the SRT document 108 available on the product status page 106.

The SRT document 108 includes status page ID 602 and status page component 604 (if necessary). The status page ID 602 is an alphanumeric code that uniquely identifies a specific status page for a product or service. The status page ID 602 is used when interacting with the API provided by the status page provider. By passing this status page ID to the API, the current status of the ticket-associated product or service is returned. If the product status page 106 exists as an independent page (i.e., representing a standalone product or service), the API will return the overall status of that page based on the provided status page ID 602.

However, in cases where the product status page 106 is part of a larger product (i.e., it represents a component within a larger system), the request must include both the status page ID 602 and the status page component 604. In this case, the API call looks for the status of the specific component within the product, with the status page ID 602 serving as the key for identifying which overall system to query, and the status page component 604 specifying which part of that system to check.

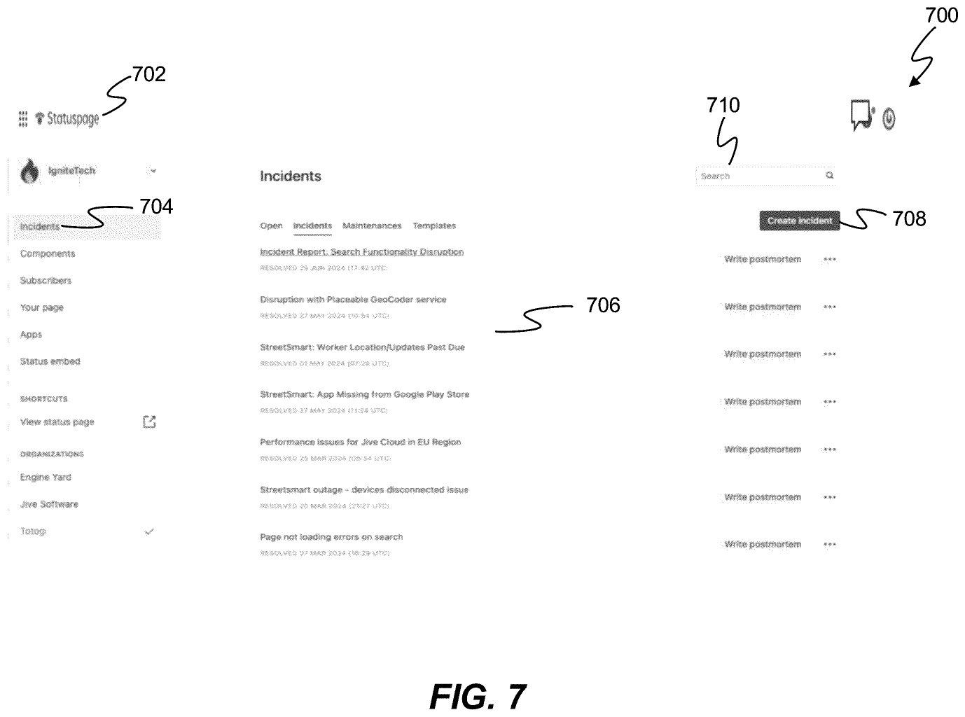

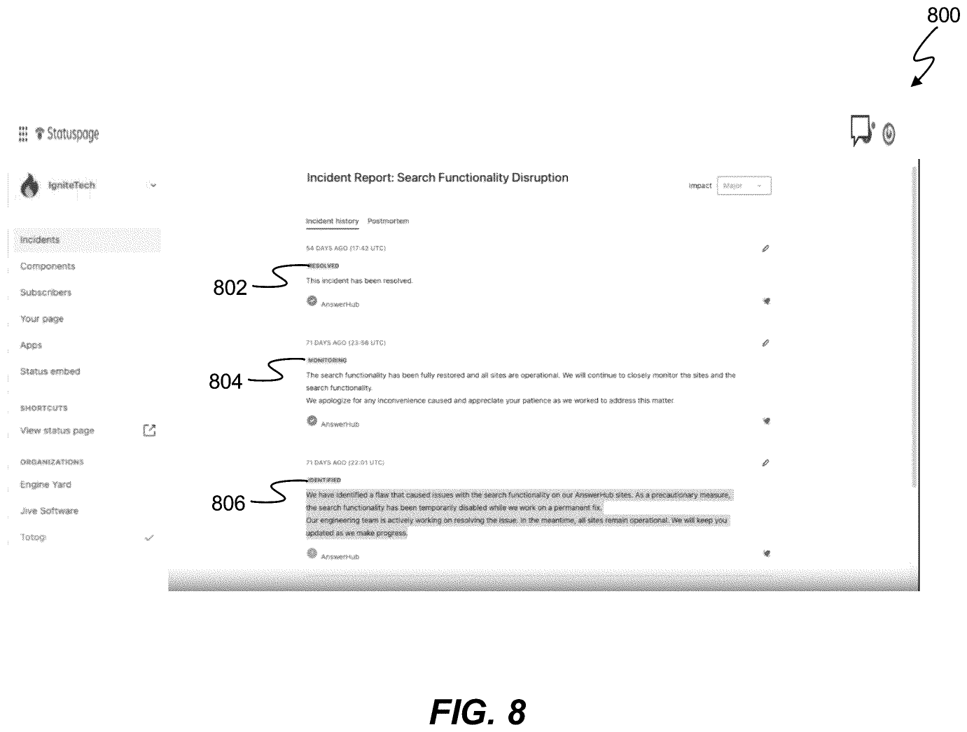

FIGS. 7 and 8 depict exemplary user interfaces disclosing a product status page showing a list of queries 706 raised by the user and the status of the queries raised, respectively.

The user interface 700 discloses a product status page 702 which shows the list of the queries 706 raised by the user using the customer support platform 102. The user can click on the tab ‘Incidents’ 704 given on the left side of the user interface 700. Further, if the user wants to create a new query, then the user can click tab 708 ‘Create an Incident’. Upon clicking on the respective tab 708 ‘Create an Incident’, the user can enter his/her query and raise a ticket. For instance, the query may be like, ‘How to write an email using XYZ tool?’, ‘How to change the color settings in the ABC tool?’, and so on.

Also, the user can go through the previously created tickets by clicking on tab 710 ‘Search’. The user can enter the corresponding keyword related to the query and search the status of the previously created tickets.

Upon clicking on tab 710 ‘Search’, the user gets access to the user interface 800, which shows the present status of the queries raised by the user. The tickets raised by the user are marked as ‘Resolved’ 802 if the ticket raised by the user is resolved, ‘Monitoring’ 804 if the ticket raised by the user is under process, ‘Identifying’ 806 if the ticket raised by the user is identified by the ticket management module 112 and will soon be rectified, and so on.

For different cases, different status descriptions are provided to the user. For instance, if the heading is ‘Resolved’ 802, the description would be ‘This incident has been resolved.’ Further, if the heading is ‘Monitoring’ 804, the description would be ‘The search functionality has been fully restored and all sites are operational. We will continue to closely monitor the sites and the search functionality. We apologize for any inconvenience and appreciate your patience as we work to address this matter.’

Also, if the heading is ‘Identified’ 806, the description would be ‘We have identified a flaw that caused an issue with the search functionality on our AnswerHub sites. As a precautionary measure, the search functionality has been temporarily disabled while we work on a permanent fix. Our engineering team is actively working on resolving the issue. In the meantime, all sites remain operational. We will keep you updated as we make progress.’

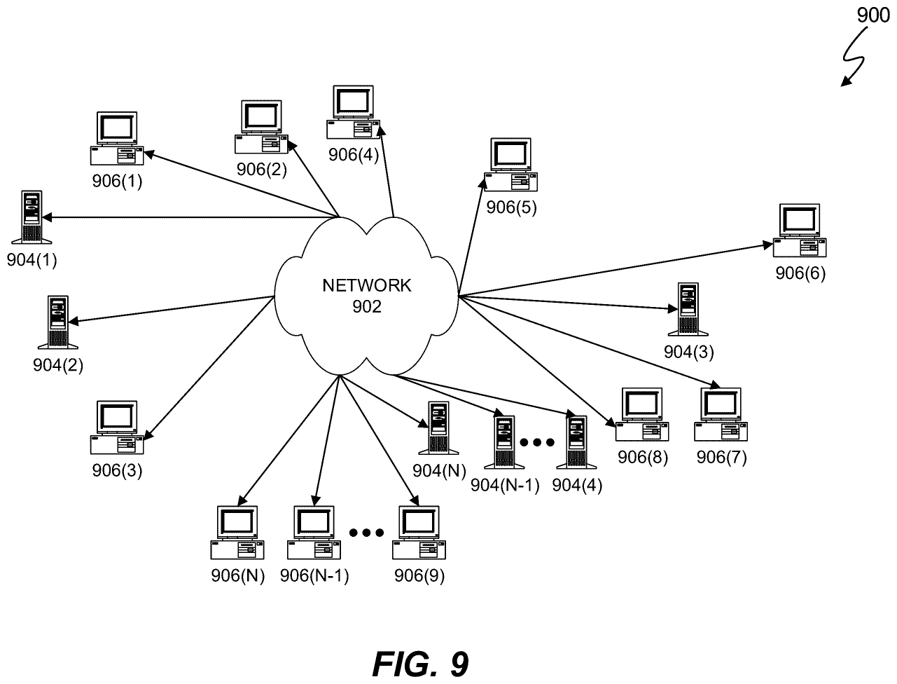

FIG. 9 is a block diagram illustrating a network environment in which the Artificial Intelligence (AI) driven service outage detection system 100 and process 200 by managing customer support tickets raised by a user using a customer support platform 102 may be practiced. Network 902 (e.g. a private wide area network (WAN) or the Internet) includes a number of networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example communications channels providing T1 or OC3 service. Client computer systems 906(1)-(N) typically access server computer systems 904(1)-(N) through a service provider, such as an internet service provider (“ISP”) by executing application specific software, commonly referred to as a browser, on one of client computer systems 906(1)-(N).

Client computer systems 906(1)-(N) and/or server computer systems 904(1)-(N) are specialized computer programmed to improve conventional computer systems to implement and utilize the Artificial Intelligence (AI) driven service outage detection system 100 and process 200 by managing customer support tickets raised by a user using a customer support platform 102. The type of computer system that can be specially programmed to implement and utilize the Artificial Intelligence (AI) driven service outage detection system 100 and process 200 by managing customer support tickets raised by a user using a customer support platform 102 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the Artificial Intelligence (AI) driven service outage detection system 100 and process 200 by managing customer support tickets raised by a user using a customer support platform 102 can be implemented using code stored in a tangible, non-transient computer readable medium and executed by one or more processors. In at least one embodiment, the Artificial Intelligence (AI) driven service outage detection system 100 and process 200 by managing customer support tickets raised by a user using a customer support platform 102 can be implemented completely in hardware using, for example, logic circuits and other circuits including field programmable gate arrays.

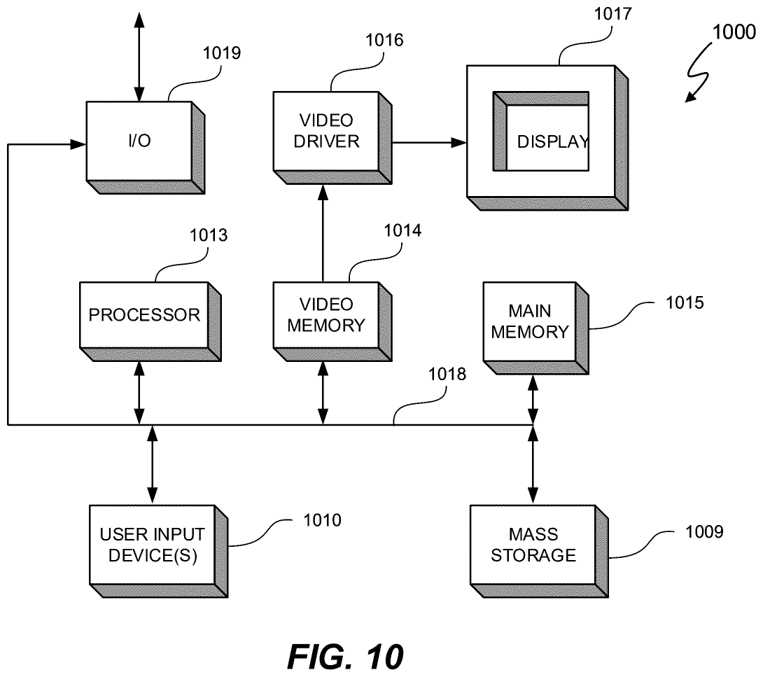

Embodiments of the Artificial Intelligence (AI) driven service outage detection system 100 and process 200 by managing customer support tickets raised by a user using a customer support platform 102 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include both fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 1009, main memory 1015, video memory 1014 and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer systems via a telephone link or to the Internet via an ISP. I/O device(s) 1019 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1009, into main memory 1015 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the display 1017. Video amplifier 1016 is well known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The Artificial Intelligence (AI) driven service outage detection system 100 and process 200 by managing customer support tickets raised by a user using a customer support platform 102 may be implemented in any type of computer system or programming or processing environment. It is contemplated that the Artificial Intelligence (AI) driven service outage detection system 100 and process 200 by managing customer support tickets raised by a user using a customer support platform 102 might be run on a stand-alone computer system, such as the one described above. The Artificial Intelligence (AI) driven service outage detection system 100 and process 200 by managing customer support tickets raised by a user using a customer support platform 102 might also be run from a server computer systems system that can be accessed by a plurality of client computer systems interconnected over an intranet network. Finally, the Artificial Intelligence (AI) driven service outage detection system 100 and process 200 by managing customer support tickets raised by a user using a customer support platform 102 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of detecting service outages and managing customer support tickets raised by a user using a customer support platform, the method comprises:
executing code using one or more processors of a computer system to cause the computer system to perform operations comprising:
capturing real-time input data from a product status page and a service request tracker (SRT) document, wherein the product status page provides updates on the operational status of the service, and the SRT document includes information related to current service outages and tickets;
detecting the service outages by monitoring the product status page, and incoming customer support tickets raised against one or more products by one or more users, wherein the incoming customer support tickets are raised by users if they have any query or complaint against the product;
comparing the details of the product status page and the SRT document to confirm the occurrence of the service outage;
automatically updating the customer support ticket routing process based on the confirmed service outage status, wherein the customer support ticket is deflected from direct intervention by support staff;
generating an automated predefined response for the user, informing them of the service outage, and providing relevant information or instructions;
automatically notifying the user with the predefined response, including service outage information, wherein the predefined response includes details about the outage status and any expected resolution or alternative support options.

2. The method of claim 1 is wherein the SRT document includes a status page ID with an alphanumeric code.

3. The method of claim 2 wherein the alpha-numeric code in the SRT document is an instruction that allows detection of the service outage incident.

4. The method of claim 1 wherein the specific text is extracted from the SRT document, including information related to current service outages and ticket routing.

5. The method of claim 1 wherein each incoming customer support ticket is categorized with a short heading and accompanied with a description, wherein the short heading and the description can be easily understood by a LLM.

6. The method of claim 1 wherein the detection of the service outage further comprises:
monitoring details of each customer support ticket;
monitoring similarities between multiple customer support tickets raised for a single product by one or more users;
scanning multiple incoming customer support tickets for similar keywords or phrases that are related to the detected service outages.

7. The method of claim 1 wherein the monitoring of the status page further comprises:
continuously accessing the product status page at predefined intervals of time for real-time updates on service performance, service outage notifications, or scheduled maintenance alerts.

8. The method of claim 1 further comprises:
utilizing NLP (Natural Language Processing) techniques to scan the incoming customer support tickets to identify keywords, or phrases that depict service outages;
comparing the identified keywords, or phrases with the predefined service outage-related terms in the SRT document;
identifying patterns in the incoming customer support tickets to detect service outages using machine learning algorithms.

9. An artificial intelligence (AI) driven service outage detection and management system when a customer support tickets are raised by a user using a customer support platform comprises:
one or more processors of a computer system; and
a memory, coupled to the one or more processors, that stores code and execution of the code by the one or more processors causes the computer system to perform operations comprising:
capturing real-time input data from a product status page and a service request tracker (SRT) document using a data collector, wherein the product status page provides updates on the operational status of the service, and the SRT document includes information related to current service outages and tickets;
detecting the service outages using a service outage detector by monitoring the product status page, and incoming customer support tickets raised against one or more products by one or more users, wherein the incoming customer support tickets are raised by users if they have any query or complaint against the product;
comparing the details of the product status page and the SRT document to confirm the occurrence of the service outage using a comparator;
automatically updating the customer support ticket routing process based on the confirmed service outage status using a customer support ticket router, wherein the customer support ticket is deflected from direct intervention by support staff;
generating an automated predefined response for the user using a response generator, informing them of the service outage, and providing relevant information or instructions;
automatically notifying the user with the predefined response, including service outage information using a notification module, wherein the predefined response includes details about the outage status and any expected resolution or alternative support options.

10. The system of claim 9 wherein the generated predefined response, along with resolution, or alternative support options are displayed to the user on a user interface integrated within the customer support platform.

11. The system of claim 9 wherein the resolution, or alternative support options presented to the user include FAQs, help articles, or status updates that can resolve user issues.

12. The system of claim 9 wherein a cloud database stores historical service outage data, customer interactions, and predefined response templates for future reference and continuous improvement of the outage detection process.

13. The system of claim 9 wherein the SRT document includes a status page ID with an alphanumeric code, that includes an instruction that allows detection of the service outage incident.

14. The system of claim 9 wherein each incoming customer support ticket is categorized with a short heading and accompanied with a description, wherein the short heading and the description can be easily understood by a LLM.

15. The system of claim 9 wherein the service outage detector utilizes NLP (Natural Language Processing) techniques to analyze the incoming customer support tickets and identify potential service outages based on user-submitted keywords or pattern.
